(19) United States
(12) Patent Application Publication
(10) Pub. No.: US 2004/0217111 A1
(43) Pub. Date: Nov. 4, 2004

(54) Infrared radiation source

(76) Inventors: Siegfried Grob, Maintal (DE); Joachim Scherzer, Bruchkobel (DE); Sven Linow, Darmstadt (DE)

Correspondence Address: FULBRIGHT & JAWORSKI, LLP, 666 FIFTH AVE, NEW YORK, NY, 10103-3198, US

(21) Appl. No.: 10/827,742

(22) Filed: Apr. 20, 2004

(30) Foreign Application Priority Data
Apr. 29, 2003 (DE) 103 19 468.1

(51) Int. Cl. H05B 3/10; H01K 1/24; H01J 1/94; H01J 1/96

(52) U.S. Cl. 219/553; 219/548; 313/274; 313/279

(57) ABSTRACT

The invention relates to an infrared radiation source having at least one electrical heat conductor situated in a long, two-ended casing tube made of quartz glass, the casing tube having at least one elevation made of quartz glass on its wall which faces the at least one heat conductor, which locally reduces the inner diameter of the casing tube. At least one heat conductor is designed as a heating coil. The casing tube has a constant outer diameter in the region of the heating coil, the elevation has a convex shape on its surface facing the heating coil, and the heating coil contacts the elevation only at the highest point of the elevation.

### BACKGROUND OF THE INVENTION

The invention relates to an infrared radiation source having at least one electrical heat conductor situated in a long, two-ended casing tube made of quartz glass, the casing tube having at least one elevation made of quartz glass on its wall which faces the at least one heat conductor, which reduces the inner diameter of the casing tube.

Such infrared radiation sources are known from U.S. Pat. No. 6,057,532. Disclosed is an infrared radiation source having a heat conductor made of carbon fibers which is situated in a casing tube made of quartz glass. Positioning cavities are disclosed for positioning and centering long, tape-like heat conductors in the casing tube which, observed along the cross section of the casing tube, are punctiform and are situated diametrically opposed at the inner wall of the casing tube. The outer diameter of the casing tube is locally modified in the region of the positioning cavities. The positioning cavities have a U-shaped profile through which the edges of a tape-like heat conductor are guided to prevent twisting of the tape.

A halogen filament lamp for general illumination having a similar structure is disclosed in EP 0 446 458 B1. Disclosed is a long bulb made of quartz glass, sealed on both ends, having a filament situated therein which can be continuously coiled in a spiral. Yokes are inserted in the bulb perpendicular to the lamp axis to support the filament, thereby locally modifying the outer diameter of the bulb.

The lamps according to U.S. Pat. No. 6,057,532 or EP 0 446 458 B1 are thus formed by an additional, subsequent deformation of the casing tube or bulb wall in the region of the outer diameter. Such processes are energy-intensive, and involve the danger of damage to the casing tube or bulb by deformation. Inevitable changes in the wall thickness of the casing tube may result in leakage, or even breakage of the lamp.

### OBJECTS AND SUMMARY OF THE INVENTION

The object of the present invention is to provide an infrared radiation source having an emitting temperature of the heat conductor in the range of ≧1000° C., preferably in the range of 1000° C. to 1250° C., which can be produced to be robust, yet in a cost-effective manner.

The object is achieved by the fact that at least one heat conductor is designed as a heating coil, the casing tube has a constant outer diameter in the region of the heating coil, the elevation has a convex shape on its surface facing the heating coil, and the heating coil contacts the elevation only at the highest point of the particular elevation.

Such an arrangement results in a purely punctiform or linear contact between the heating coil and the casing tube, so that no modifications of the outer diameter of the casing tube are necessary. The heating coil may be placed directly in the casing tube without additional mounting parts such as spacers.

A susceptibility to breakage of the infrared radiation source is minimized by an essentially uniform wall thickness. In addition, the heat conduction from the heating coil to the casing tube is minimized so that devitrification of the casing tube does not occur until temperatures approximately 200° C. above the critical temperature, which in a planar contact between casing tube and heating coil results in devitrification of the casing tube. Surprisingly, it has been shown that, because of the purely punctiform or linear contact between the heating coil and the casing tube, devitrification of the casing tube does not occur in the infrared radiation source according to the invention when the heating coil reaches a temperature above the critical temperature, even without additional cooling of the casing tube. The reason is that the dissipation of heat through the casing tube and the radiation of heat from the casing tube itself allow sufficient cooling of the elevations, so that devitrification either does not occur at all—or, in the event that devitrification occurs at the contact points between the heating coil and elevations—cannot spread over the entire elevation.

The infrared radiation source can therefore be produced more quickly, cost-effectively, and with lower reject rates.

It has proven to be advantageous if the elevation(s) describe at least one line from one end of the casing tube to the other.

The at least one line can be formed from a single long elevation. The linear elevation may have a uniform or variable cross section.

However, the at least one line may also be formed from a succession of individual elevations. The linear elevation preferably has a uniform cross section.

It has proven to be advantageous if, viewed along the cross section of the casing tube, at least three elevations are situated uniformly distributed over the inner diameter of the casing tube so that the heating coil is not able to come into contact with. any other sections of the casing tube besides the elevations. The maximum number of elevations is limited due to both technical and economic reasons. It has been found to be particularly advantageous if 5 to 6 elevations are situated uniformly distributed over the inner diameter of the casing tube, viewed along the cross section of the casing tube.

Furthermore, it has proven to be advantageous if the casing tube has a longitudinal axis and the at least one line runs parallel to the longitudinal axis or spirally about the longitudinal axis of the casing tube.

In a further advantageous embodiment, the casing tube may also have a longitudinal axis, whereby the elevation(s) describe at least one circular line about the longitudinal axis of the casing tube. It is advantageous for the at least one circular line to be formed from a single long elevation. The linear elevation may have a uniform or variable cross section.

It has also proven to be advantageous if the at least one line is formed from a succession of individual elevations. The linear elevations then advantageously have a uniform cross section.

It is preferable for the inner diameter of the casing tube to be reduced by approximately 10% to 20% in the region of the elevations. For an inner diameter of a substantially cylindrical casing tube having an annular cross section of 18 mm, elevations in the range of about 1 mm, for example, would be advantageous, so that the inner diameter in the region of the elevations is reduced to approximately 16 mm.

The use of a heating coil made of tungsten wire, a carbon fiber material, graphite, graphite paper, an iron-chromium-aluminum alloy, a nickel-chromium alloy, or a nickel-chromium-iron alloy has proven to be advantageous.

When the heating coil is made of tungsten wire, a carbon fiber material, graphite, or graphite paper, it has proven to be advantageous for the casing tube to be sealed at its ends in such a way that it encloses the at least one electrical heat conductor.

When the heating coil is made of an iron-chromium-aluminum alloy, a nickel-chromium alloy, or a nickel-chromium-iron alloy, it has proven to be advantageous for the casing tube to be open on at least one of its ends so that an oxidizing atmosphere surrounds the at least one electrical heat conductor.

Furthermore, it has been shown to be advantageous for the casing tube to be designed as a twin tube having two ducts, the casing tube having a heating coil in at least one of the two ducts.

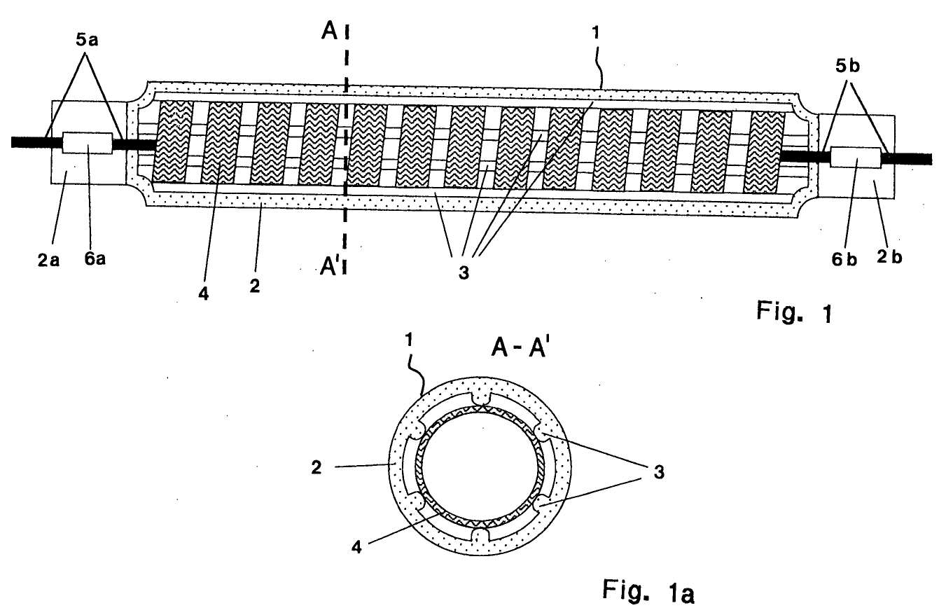

FIGS. 1 through 6a explain the infrared radiation source according to the invention.

FIG. 1 shows a longitudinal section through an infrared radiation source according to the invention;

FIG. 1a shows cross section A-A′ through the infrared radiation source from FIG. 1;

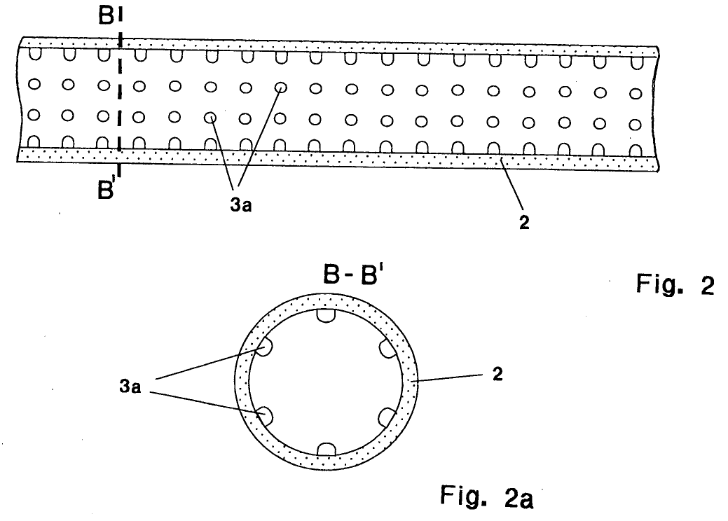

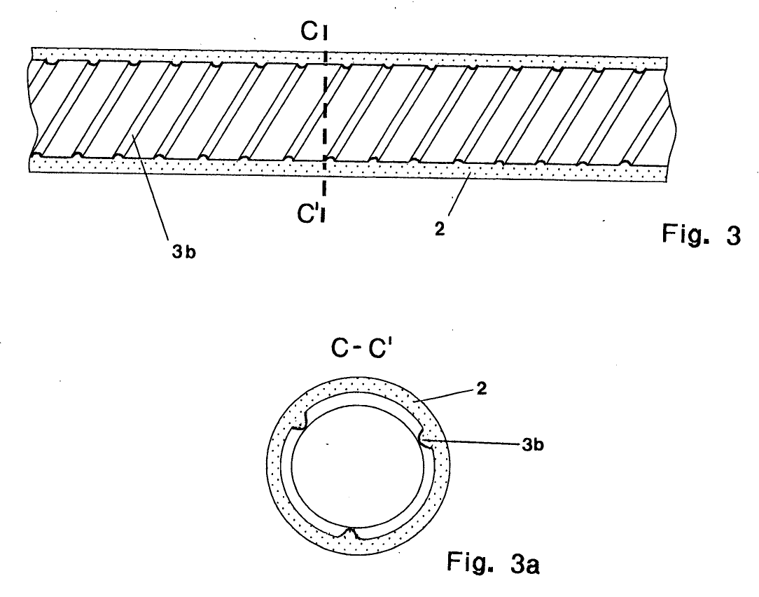

FIG. 2 shows a longitudinal section through a casing tube suitable for an infrared radiation source according to the invention;

FIG. 2a shows cross section B-B′ through the casing tube from FIG. 2;

FIG. 3 shows a longitudinal section through a casing tube suitable for an infrared radiation source according to the invention;

FIG. 3a shows cross section C-C′ through the casing tube from FIG. 3;

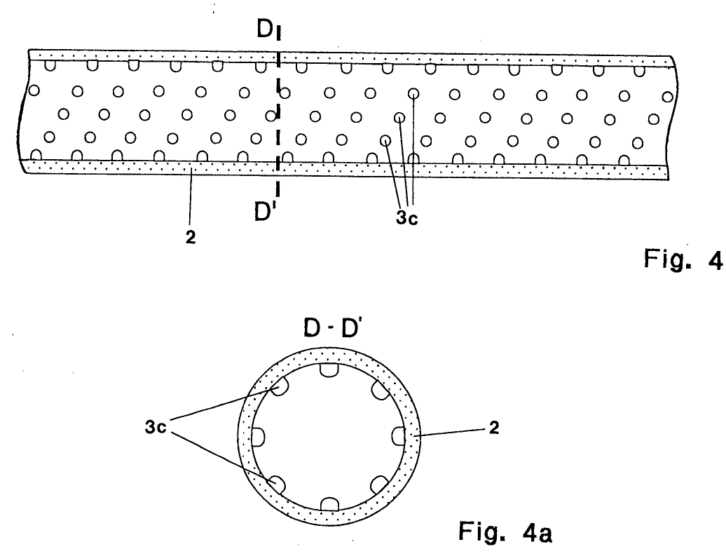

FIG. 4 shows a longitudinal section through a casing tube suitable for an infrared radiation source according to the invention;

FIG. 4a shows cross section D-D′ through the casing tube from FIG. 4;

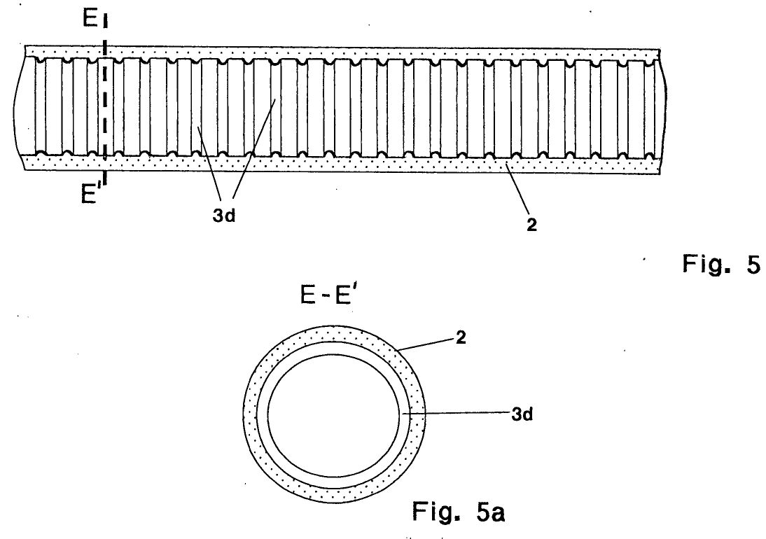

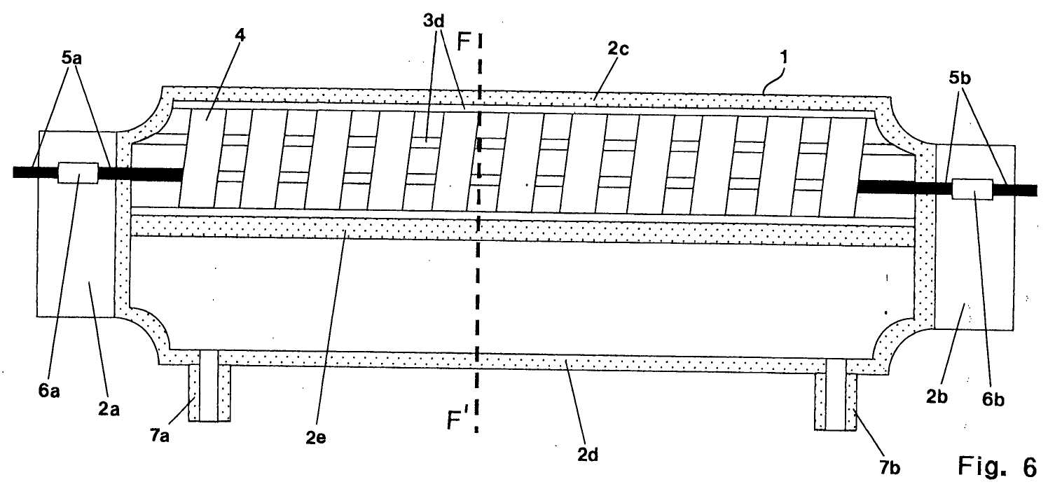

FIG. 5 shows a longitudinal section through a casing tube suitable for an infrared radiation source according to the invention;

FIG. 5a shows cross section E-E′ through the casing tube from FIG. 5;

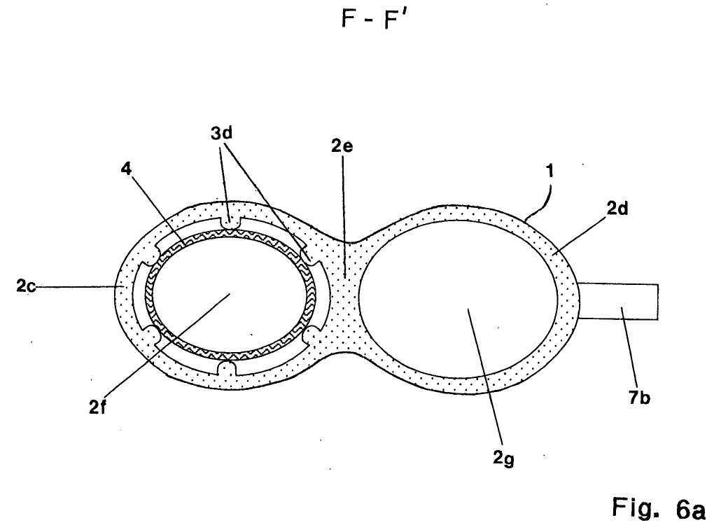

FIG. 6 shows a longitudinal section through an infrared radiation source according to the invention having a twin tube as casing tube; and

FIG. 6a shows cross section F-F′ through the infrared radiation source from FIG. 6.

### DETAILED DESCRIPTION

FIG. 1 shows the longitudinal section of an infrared radiation source 1 having a casing tube 2 made of quartz glass and having an inner diameter of 18 mm, the diameter being reduced to 16 mm in the region of elevations 3. On its inner diameter, casing tube 2 has elevations 3 made of quartz glass which extend in a straight line from one end of casing tube 2 to the other. A heating coil 4 made of carbon fiber material is situated in casing tube 2 in such a way that the outer diameter of heating coil 4 is able to contact elevations 3 only at their highest points. In practice, however, for an infrared radiation source 1 only in isolated cases do spiral regions of heating coil 4 rest on elevations 3. Casing tube 2 is sealed at both ends by press seals 2a, 2b known to those skilled in the art, the electrical contacting of heating coil 4 being achieved by electrical lines 5a, 5b and thin molybdenum foils 6a, 6b which are embedded gas-tight into press seals 2a, 2b. Heating coil 4 may be operated with a long service life at temperature up to 1200° C. Power outputs of greater than 90 W/cm are achieved for a heating coil 4 made of carbon fiber material. For a heating coil made of an iron-chromium-aluminum alloy in a casing tube open at both ends, power outputs of greater than 50 W/cm are achieved.

FIG. 1a shows cross section A-A′ of infrared radiation source 1 from FIG. 1. Six elevations 3 can be seen on the inner diameter of casing tube 2 which have an approximately semicircular cross section. Heating coil 4 thus contacts elevations 3 only at their highest points.

FIG. 2 shows a longitudinal section through a casing tube 2 suitable for an infrared radiation source according to the invention. On its inner diameter, casing tube 2 has individual elevations 3a made of quartz glass which extend in a straight line from one end of casing tube 2 to the other.

FIG. 2a shows cross section B-B′ through casing tube 2 from FIG. 2. Six elevations 3a on the inner diameter of casing tube 2 can be seen which have an approximately semicircular cross section.

FIG. 3 shows a longitudinal section through another casing tube 2 suitable for an infrared radiation source according to the invention. On its inner diameter, casing tube 2 has an elevation 3b made of quartz glass which extends spirally from one end of casing tube 2 to the other, about the longitudinal axis of same.

FIG. 3a shows cross section C-C′ through casing tube 2 from FIG. 3.

FIG. 4 shows a longitudinal section through another casing tube 2 suitable for an infrared radiation source according to the invention. On its inner diameter, casing tube 2 has individual elevations 3c made of quartz glass which extend spirally from one end of casing tube 2 to the other, about the longitudinal axis of same.

FIG. 4a shows cross section D-D′ through casing tube 2 from FIG. 4. Eight elevations 3c can be seen on the inner diameter of casing tube 2 which have an approximately semicircular cross section.

FIG. 5 shows a longitudinal section through another casing tube 2 suitable for an infrared radiation source according to the invention. On its inner diameter, casing tube 2 has elevations 3d made of quartz glass which extend in a circular fashion about the longitudinal axis of casing tube 2.

FIG. 5a shows cross section E-E′ through casing tube 2 from FIG. 5.

FIG. 6 shows a longitudinal section through an infrared radiation source 1 having a casing tube made of quartz glass and designed as twin tube 2c, 2d, 2e. Twin tube 2c, 2d, 2e has a first tube 2c connected to a second tube 2d by means of a bridge 2e. First tube 2c has on its inner diameter elevations 3d made of quartz glass which extend in a circular fashion about the longitudinal axis of first tube 2c. A heating coil 4 made of carbon fiber material is situated in first tube 2c in such a way that the outer diameter of heating coil 4 contacts elevations 3d only at their highest points. Second tube 2d has feed and discharge lines 7a, 7b, respectively, which are suitable for connecting second tube 2d to a cooling water line.

Tubes 2c, 2d are sealed at both ends by press seals 2a, 2b known to those skilled in the art, the electrical contacting of heating coil 4 being achieved by electrical lines 5a, 5b and thin molybdenum foils 6a, 6b which are embedded gas-tight into press seals 2a, 2b.

FIG. 6a shows cross section F-F′ through infrared radiation source 1 from FIG. 6. Tubes 2c, 2d can be seen, which are connected to one another in the region of bridge 2e. Tube 2c has a duct 2f and tube 2d has a duct 2g. A heating coil 4 is situated in tube 2c which contacts elevations 3d only at their highest points.

Further embodiments of the infrared radiation source according to the invention may be developed in a simple manner by one having average skills in the art.

1. An infrared radiation source comprising at least one electrical heat conductor situated in a long, two-ended casing tube made of quartz glass, the casing tube having at least one elevation made of quartz glass on its wall which faces the at least one heat conductor, which locally reduces the inner diameter of the casing tube, whereby at least one heat conductor is designed as a heating coil, the casing tube has a constant outer diameter in the region of the heating coil, the elevation has a convex shape on its surface facing the heating coil, and the heating coil contacts the elevation only at the highest point of the elevation.

2. An infrared radiation source according to claim 1, wherein the elevation(s) describe at least one line from one end of the casing tube to the other.

3. An infrared radiation source according to claim 2, wherein the at least one line is formed from a single long elevation.

4. An infrared radiation source according to claim 3, wherein the linear elevation has a uniform cross section.

5. An infrared radiation source according to claim 3, wherein the linear elevation has a variable cross section.

6. An infrared radiation source according to claim 2, wherein the at least one line is formed from a succession of individual elevations.

7. An infrared radiation source according to claim 6, wherein the linearly situated elevations have a uniform cross section.

8. An infrared radiation source according to claim 2, wherein the casing tube has a longitudinal axis and that the at least one line runs parallel to the longitudinal axis of the casing tube.

9. An infrared radiation source according to claim 2, wherein the casing tube has a longitudinal axis and that the at least one line runs spirally about the longitudinal axis of the casing tube.

10. An infrared radiation source according to claim 1, wherein the casing tube has a longitudinal axis and that the elevation(s) describe at least one circular line about the longitudinal axis of the casing tube.

11. An infrared radiation source according to claim 10, wherein the at least one circular line is formed from a single long elevation.

12. An infrared radiation source according to claim 11, the linear elevation 3 has a uniform cross section.

13. An infrared radiation source according to claim 11, wherein the linear elevation has a variable cross section.

14. An infrared radiation source according to claim 10, wherein the at least one line is formed from a succession of individual elevations.

15. An infrared radiation source according to claim 14, the linearly situated elevations have a uniform cross section.

16. An infrared radiation source according to claim 1, wherein the heating coil is made of a tungsten wire.

17. An infrared radiation source according to claim 1, wherein the heating coil is made of a carbon fiber material, graphite, or graphite paper.

18. An infrared radiation source according to claim 1, wherein the heating coil is made of an iron-chromium-aluminum alloy, a nickel-chromium alloy, or a nickel-chromium-iron alloy.

19. An infrared radiation source according to claim 16, wherein the casing tube 2 is sealed gas tight at its ends in such a way that it encloses the at least one electrical heat conductor.

20. An infrared radiation source according to claim 18, wherein the casing tube is open on at least one of its ends so that an oxidizing atmosphere surrounds the at least one electrical heat conductor.

21. An infrared radiation source according to claim 1, wherein the casing tube is designed as a twin tube having two ducts, the casing tube having the heating coil in at least one of the two ducts.

22. An infrared radiation source according to claim 17, wherein the casing tube is sealed gas tight at its ends in such a way that it encloses the at least one electrical heat conductor.
